(19) United States
(12) Patent Application Publication
(10) Pub. No.: US 2025/0303425 A1
(43) Pub. Date: Oct. 2, 2025

(54) Centrifuge Accessory for Transdermal Pens

(71) Applicant: CHEWY, INC., Plantation, FL (US)

(72) Inventors: Ronald B. Flournoy, Hopewell, VA (US); Michelle Dawn Karsner, Charlestown, IN (US); Vincent Thai, Louisville, KY (US); Warren David Finlinson, Simpsonville, KY (US); Abigayle Erin Carbone, Louisville, KY (US)

(73) Assignee: CHEWY, INC., Plantation, FL (US)

(21) Appl. No.: 19/096,207

(22) Filed: Mar. 31, 2025

Related U.S. Application Data
(60) Provisional application No. 63/572,666, filed on Apr. 1, 2024.

(51) Int. Cl. B04B 7/12; B04B 5/04

(52) U.S. Cl. CPC B04B 7/12; B04B 5/0407

(57) ABSTRACT

Described herein is a centrifuge accessory for processing a transdermal pen comprising a base having a central axis aligned with a rotor of a centrifuge, a pen support for removably attaching the transdermal pen to the base in a radial configuration, and a rod protruding from base. The rod has a central axis aligned with the transdermal pen when the transdermal pen is attached to the base.

### CROSS REFERENCE TO RELATED APPLICATIONS

The present application claims priority to and the benefit of U.S. Provisional Patent Application No. 63/572,666, filed Apr. 1, 2024, which is incorporated herein by reference in its entirety for any and all purposes.

### TECHNICAL FIELD

The present disclosure generally relates to a centrifuge accessory for easily and efficiently securing transdermal pens that are filled with a medicament and processing the filled pens in a centrifuge to remove gas bubbles from the filled transdermal pens. The medicament in the filled pens may be an anhydrous cream and an active ingredient.

In some known systems, when filling transdermal pens, a user taps the filled pen on a countertop, or similar surface, so that the gas rises to the top of the pen and the material in the filled pen is brought to the bottom of the pen. This tapping method is performed on each filled pen individually which can require approximately 30 seconds to 60 seconds to remove the gas bubbles from each pen. Furthermore, manually tapping each pen poses a risk of injury to the user and/or damage to the pen.

### BRIEF DESCRIPTION OF THE DRAWINGS

The following detailed description of embodiments of the transdermal pen centrifuge accessory, will be better understood when read in conjunction with the appended drawings of an exemplary embodiment. It should be understood, however, that the invention is not limited to the precise arrangements and instrumentalities shown.

In the drawings:

FIG. 1 is a perspective view of a transdermal pen centrifuge accessory in accordance with an exemplary embodiment of the present disclosure;

FIG. 2 is a top view of a transdermal pen centrifuge accessory in accordance with an exemplary embodiment of the present disclosure;

FIG. 3 is an image of a centrifuge device that is compatible with a transdermal pen centrifuge accessory in accordance with an exemplary embodiment of the present disclosure;

FIG. 4 is an image of a centrifuge device that is compatible with a transdermal pen centrifuge accessory in accordance with an exemplary embodiment of the present disclosure; and

FIG. 5 is a flowchart illustrating a method of using a centrifuge accessory in accordance with an exemplary embodiment of the present disclosure.

### DETAILED DESCRIPTION

When filling transdermal pens with a medicament, gas pockets or bubbles may form inside the filled pens, that need to be released from the transdermal pens. The centrifuge accessory allows for a user to easily clip the filled transdermal pens into the centrifuge accessory and process the pens in a centrifuge machine to remove the gas bubbles from the filled transdermal pens. This method may be used in lieu of known tapping methods.

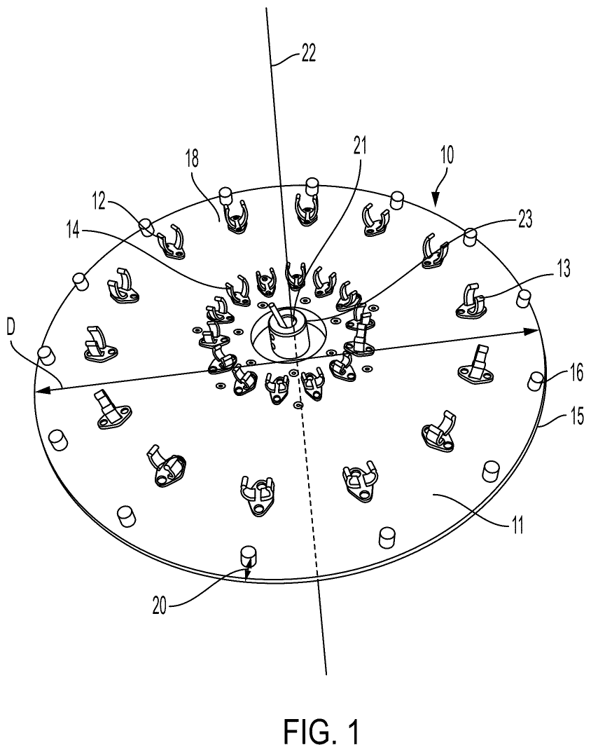

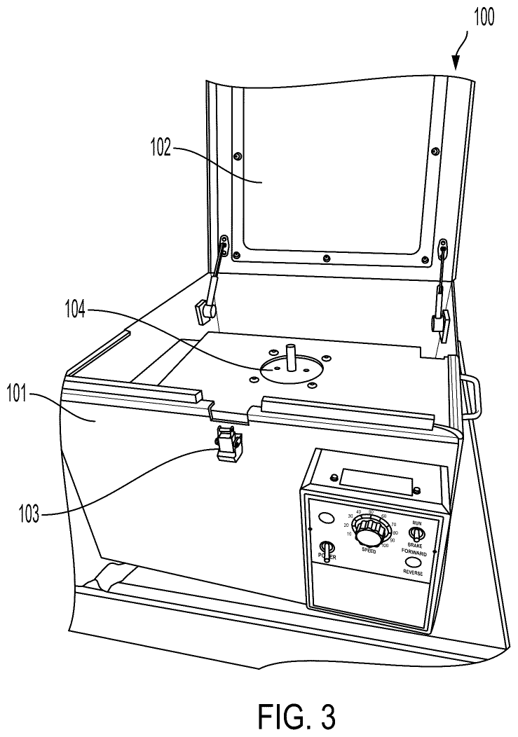

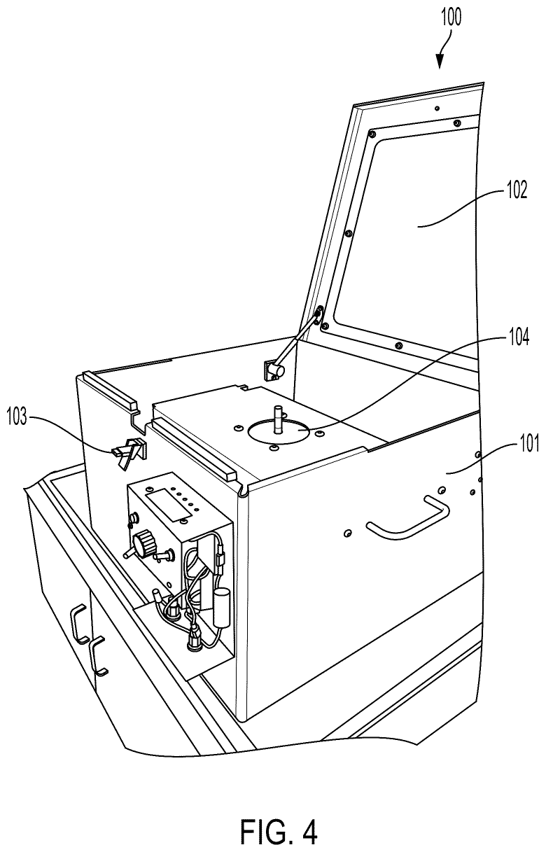

Referring to the drawings in detail, wherein like reference numerals indicate like elements throughout, there is shown in FIGS. 1-5 a transdermal pen centrifuge accessory 10 (also referred to as “centrifuge accessory”), a compatible centrifuge 100 and a method 200 for using the centrifuge accessory 10, in accordance with an exemplary embodiment of the present invention. The centrifuge accessory 10 is compatible with transdermal pens 1. Transdermal pens 1 may include those that are standard in the compound pharmacy industry.

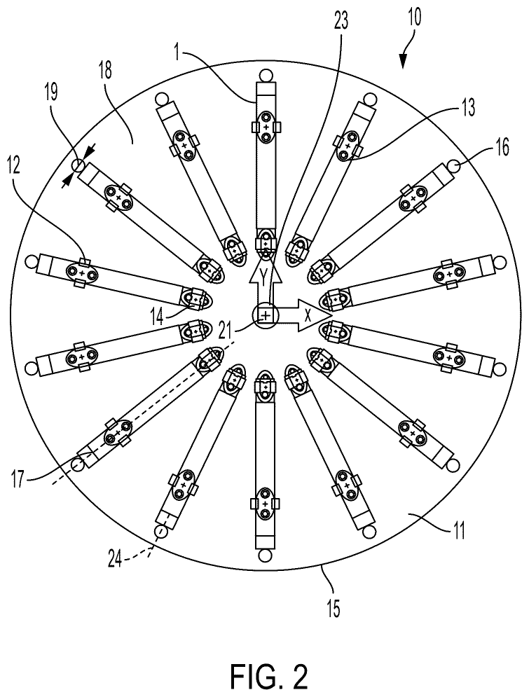

In the embodiment of FIGS. 1-2, the centrifuge accessory 10 for processing transdermal pens includes a base 11 having a central axis 22 aligned with a rotor 23 of a centrifuge 100, a pen support 13 for removably attaching the transdermal pen 1 to the base 11 in a radial configuration and a rod 16 protruding from the base 11. Rod 16 is substantially aligned with center point 21 of base 11 such that a central axis 24 of rod 16 is co-axial with a centerline 17 of pen 1 passing through center point 21 when the transdermal pen 1 is attached to the base 11.

In some embodiments, the base 11 includes a polymer surface. In some embodiments, the base 11 comprises a polymer (e.g., a thermoplastic polymer). In some embodiments, the base 11 comprises polypropylene. In some embodiments, the base 11 includes a planar surface 18 that is substantially normal to a rotation axis of the rotor (e.g., central axis 22) when the base 11 is operationally attached to the centrifuge. In some embodiments, the base 11 extends circumferentially around the central axis 22 of the rotor. In some embodiments the base has a diameter D of about 17 in., about 17.5 in., about 18 in., about 18.5 in., about 19 in., about 19.5 in., about 20 in., about 20.5 in., or about 21 in.

In some embodiments, the pen support 13 is configured to orient a longitudinal axis of the transdermal pen 1 normal to a rotational axis of the rotor. In some embodiments, the pen support 13 causes the centerline 17 of the transdermal pen 1 to intersect with the central axis of the rotor. In some embodiments, the pen support 13 includes a spring clip or a plurality of spring clips. In other embodiments, the pen support 13 includes a basket to secure the transdermal pen 1 on the base 11. In other embodiments, the pen support 13 includes a strap to secure the transdermal pen 1 on the base 11.

In some embodiments, the pen support 13 includes a pair of spring clips. In some embodiments, the pair of spring clips include a larger spring clip 12 disposed closer to the outer perimeter 15 of the base 11 and a smaller spring clip 14 closer to the center point 21 of the base 11. In some embodiments, the larger spring clip 12 has a diameter of about 0.79 in., about 0.80 in., about 0.81 in., about 0.82 in., about 0.83 in., about 0.84 in., or about 0.85 in. In some embodiments, the larger spring clip 12 has a diameter of about ½ in., about 13/16 in., about ⅞ in., or about 1 in. In some embodiments, the smaller spring clip 14 has a diameter of about 0.60 in., about 0.61 in., about 0.62 in., about 0.63 in., about 0.64 in., about 0.65 in., about 0.66 in., about 0.67 in., about 0.68in., about 0.69 in., or about 0.70 in. In some embodiments, the smaller spring clip 14 has a diameter of about 9/16 in., about ⅝ in., about 11/16 in., about ¾ in., about 13/16 in., about ⅞ in., about 15/16 in., or about 1 in. In some embodiments, each pen support 13 includes one spring clip. In some embodiments, each pen support 13 includes more than two spring clips. In some embodiments, the spring clips are made of a plastic material (e.g., polymer, elastomer, thermoplastic). In some embodiments, the spring clip is configured to provide audible feedback (such as a clicking sound) when the transdermal pen 1 has been secured in the spring clips 12 and 14.

In some embodiments, the spring clips 12 and 14 are removably attached to the base 11. The spring clips 12 and 14 may be replaceable on the base 11 in the same different locations. Each spring clips 12 and 14 may be interchangeable with one or more spring clips 12 and 14. Spring clips 12 and 14 may be replaced easily if they are broken, without requiring a new centrifuge accessory 10. In some embodiments, the base 11 is configured to receive up to eight, up to ten, up to twelve, or up to fourteen transdermal pens 1. The base 11 may be configured to hold an even number of transdermal pens 1.

In some embodiments, the rod 16 is configured to limit lateral movement of transdermal pen 1 in place while the pens are subject to centrifugal force from the operation of centrifuge. In some embodiments, the rod 16 includes a cylindrical outer surface having a rod diameter 19 that is smaller than a diameter of the transdermal pen 1 at a point where a distal end of the transdermal pen 1 engages the rod 16 during use of the centrifuge 100. In some embodiments, rod 16 has an outer diameter of 0.2 in., about 0.3 in., about 0.4 in., about 0.5 in., about 0.6 in., about 0.7 in., or about 0.8 in which may be with about 50%, about 51%, about 52%, about 53%, about 54%, about 55%, about 56%, about 57%, about 58%, about 59%, or about 60% percent of a diameter of transdermal pen 1. In some embodiments, the longitudinal axis 24 of the rod 16 and a centerline 17 of pen support 13 are aligned with the center point 21 of the base 11. In some embodiments, rod 16 includes a circular cross section, a rectangular cross section or a square cross section.

In some embodiments, the rod 16 is positioned at an interior offset 20 from an outer edge 15 of the base 11 and the rod 16 is configured to engage a distal end of the transdermal pen 1 when the transdermal pen 1 is secured to the base 11. In some embodiments, the interior offset 20 is about 0.20 in., about 0.21 in., about 0.22 in., about 0.23 in., about 0.24 in., about 0.25 in., about 0.26 in., about 0.27 in., about 0.28 in., about 0.29 in., or about 0.30 in.

In some embodiments, the centrifuge accessory 10 is compatible with a Leeson Speedmaster centrifuge 100. The centrifuge 100 includes an outer case 101, a viewing window 102, a security latch 103 to prevent opening when centrifuge 100 is spinning. Centrifuge 100 is scaled to prevent accidental discharge of medicament outside the case. In some embodiments, the centrifuge is substantially closed. In some embodiments, the centrifuge is vented.

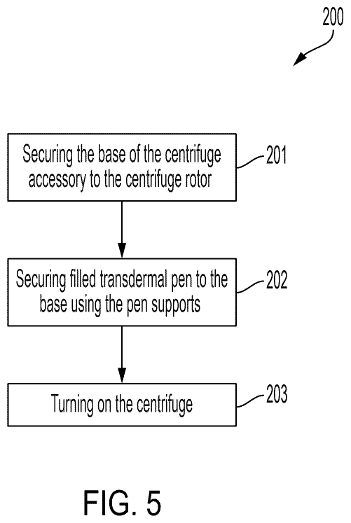

As illustrated in FIG. 5, embodiments of the present disclosure include a method 200 of removing gaseous phase from a transdermal pen. The method may include step 201 securing a base 11 to a centrifuge rotor in a configuration that causes the base 11 to spin about a central axis when the centrifuge 100 is operated. Step 202, for example, may include securing the transdermal pen 1 to the base 11 with a pen support 13 coupled to the base in a radial alignment with a rod 16 configured to retain the transdermal pen 1 in a fixed position relative to the base 11 when the centrifuge 100 is operated. The centrifuge table 104 may then be rotated (step 203) to remove the gaseous phase from the fluid within transdermal pens 1.

In some embodiments, the speed centrifuge table 104 is configured to rotation at about 500 rpm, about 550 rpm, about 600 rpm, about 650 rpm, about 700 rpm, about 750 rpm, about 800 rpm, about 850 rpm, about 900 rpm, about 950 rpm, or about 1000 rpm. In some embodiments, the angular velocity of centrifuge table 104 is determined based upon a viscosity of the material in the transdermal pen 1. In some embodiments, the angular velocity is adjustable at centrifuge 100 and the present invention is operable at speeds of about 850 rpm. In some embodiments, the transdermal pens 1 contain an anhydrous cream and an active ingredient. In some embodiments, the transdermal pens 1 are filled with another fluid and an active ingredient.

In some embodiments, the method includes operating the centrifuge 100 to induce a gas phase to migrate to a position such that a unitary gas phase bubble forms along and transects a longitudinal axis of the transdermal pen 1. In some embodiments, the method includes priming the transdermal pen 1 to evacuate the gas bubble. In some embodiments, the base 11 includes a planar surface 18 that is normal to a rotation axis 22 of the rotor 23 when the base 11 is operationally attached to the centrifuge rotor 23.

In some embodiments, the securing the transdermal pen 1 to the base 11 includes snapping the transdermal pen 1 into a pen support 13 fixed to the base 11. In some embodiments, the securing the transdermal pen 1 to the base 11 includes securing the transdermal pen 1 into a plurality of spring clips (e.g., 12, 14) fixed to the base 11. In some embodiments, the method includes processing up to fourteen transdermal pens 1 simultaneously on the base 11. In some embodiments, an even number of pens is required to maintain a balance load when centrifuge 10 is operated with centrifuge accessory 10. For example, in some embodiments, four pens, six pens, eight pens, ten pens, twelve pens, or fourteen pens may be secured to pen support 13 while allowing for a balanced load. In the event an uneven number of pens needs to be processed, dummy may be added on the centrifuge accessory 10. Dummy pens may including a fluid of similar weight to the medicament filled pens to maintain balance.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A centrifuge accessory for processing a transdermal pen, the centrifuge accessory comprising:
a base having a central axis aligned with a rotor of a centrifuge;
a pen support for removably attaching the transdermal pen to the base in a radial configuration; and
a rod protruding from base, the rod having a central axis aligned with the transdermal pen when the transdermal pen is attached to the base.

2. The centrifuge accessory of claim 1, wherein the base includes planar surface that is normal to a rotation axis of the rotor when the base is operationally attached to the centrifuge.

3. The centrifuge accessory of claim 1, wherein the pen support includes a spring clip.

4. The centrifuge accessory of claim 1, wherein the pen support includes a pair of spring clips.

5. The centrifuge accessory of claim 1, wherein the base is configured to receive up to 14 transdermal pens 1.

6. The centrifuge accessory of claim 1, wherein the rod includes a cylindrical outer surface having a rod diameter that is smaller than a diameter of the transdermal pen at a point where a distal end of the transdermal pen engages the rod during use of the centrifuge.

7. The centrifuge accessory of claim 1, wherein the central axis of the rod and a centerline of pen support are aligned with the central axis of the base.

8. The centrifuge accessory of claim 1, wherein pen support is configured to orient a longitudinal axis of the transdermal pen normal to a rotational axis of the rotor.

9. The centrifuge accessory of claim 1, wherein the rod is positioned at an interior offset from an outer edge of the base and the rod is configured to engage a distal end of the transdermal pen when the transdermal pen is secured to the base.

10. The centrifuge accessory of claim 1, wherein the centrifuge accessory is processed in a centrifuge that is substantially closed.

11. The centrifuge accessory of claim 1, wherein the centrifuge accessory is processed in a centrifuge that is vented.

12. A method of removing gaseous phase from a transdermal pen comprising:
securing a base to a centrifuge rotor on a centrifuge in a configuration that causes the base to spin about a central axis when the centrifuge is operated; and
securing the transdermal pen to the base with a pen support coupled to the base in a radial alignment with a rod configured to retain the transdermal pen in a fixed position relation to the base when the centrifuge is operated.

13. The method of claim 12 further comprising:
operating the centrifuge to induce a gas bubble to migrate to a position such that a longitudinal axis of the transdermal pen transects the gas bubble.

14. The method of claim 13 further comprising:
priming the transdermal pen to evacuate the gas bubble.

15. The method of claim 12, wherein the base includes a planar surface that is normal to a rotation axis of the rotor when the base is operationally attached to the centrifuge rotor.

16. The method of claim 12, wherein securing the transdermal pen to the base includes snapping the transdermal pen into a spring clip fixed to the base.

17. The method of claim 12, wherein securing the transdermal pen to the base includes securing the transdermal pen into a plurality of spring clips fixed to the base.

18. The method of claim 12, wherein up to 14 transdermal pens are processed simultaneously on the base.

19. The method of claim 12, wherein the rod includes a cylindrical outer surface having a rod diameter that is smaller than a diameter of the transdermal pen at a point where the transdermal pen engages the rod during use of the centrifuge.

20. The method of claim 16, wherein the central axis of the rod and the spring clip are aligned with the central axis of the base.

21. The method of claim 12, wherein spring clip is configured to orient a longitudinal axis of the transdermal pen normal to a rotational axis of the rotor.

22. The method of claim 12, wherein the rod is positioned at an interior offset from an outer edge of the base.
